(19) United States
(12) Patent Application Publication
(10) Pub. No.: US 2019/0054660 A1
(43) Pub. Date: Feb. 21, 2019

(54) APPARATUS AND METHOD FOR HEATED AIR FLOW CONTROL IN GRANULAR MATERIAL DRYING

(71) Applicant: Stephen B. MAGUIRE, West Chester, PA (US)

(72) Inventor: Stephen B. MAGUIRE, West Chester, PA (US)

(21) Appl. No.: 16/166,004

(22) Filed: Oct. 19, 2018

Related U.S. Application Data
(63) Continuation-in-part of application No. 15/457,051, filed on Mar. 13, 2017.
(60) Provisional application No. 62/574,351, filed on Oct. 19, 2017.
(60) Provisional application No. 62/307,945, filed on Mar. 14, 2016.

(51) Int. Cl. B29B 13/06; F26B 21/12; F26B 17/14; F26B 3/06

(52) U.S. Cl. CPC B29B 13/06; F26B 21/12; F26B 2200/08; F26B 3/06; F26B 17/14

(57) ABSTRACT

Apparatus and methods for simultaneously drying a plurality of different polymer materials preparatory to molding or extrusion into finished or semi-finished products includes a heater, a blower, a collection of hoppers, conduits connecting the blower with the hoppers, air speed indicators for measuring speed of heating air entering the heating air inlet of the hoppers, and a microprocessor for controlling all of the above.

### CROSS REFERENCE TO RELATED PATENT APPLICATIONS

This patent application claims the benefit of the priority of U.S. provisional application Ser. No. 62/574,351, filed 19 Oct. 2017 in the name of Stephen B. Maguire and entitled “Heated Air Flow Control Method And Apparatus For Granular Material Drying” the priority is claimed under 35 USC 120.

This patent application is further a continuation-in-part under 35 USC 120 and claims the benefit of the priority of co-pending U.S. patent application Ser. No. 15/457,051, filed 13 Mar. 2017 in the name of Stephen B. Maguire and entitled “Dryer Control By Regulation Of Hot Air Supply Rate.” The '051 application was published 14 Sep. 2017 as US 2017/061261 A1.

This patent application further claims the priority of U.S. provisional application Ser. No. 62/307,945, filed 14 Mar. 2016 in the name of Stephen B. Maguire. The priority of the '945 application is claimed under 35 USC 120 through the '051 application.

### STATEMENT RESPECTING FEDERAL FUNDING RESPECTING THIS INVENTION AND PATENT APPLICATION

Not applicable—this invention was conceived and developed entirely using private source funding; this patent application is being filed and paid for entirely by private source funding.

### INCORPORATION BY REFERENCE

This patent application incorporates by reference the disclosure of U.S. patent application Ser. No. 15/457,051, published 14 Sep. 2017 as US 2017/061261 A1.

This patent application further incorporates by reference U.S. Pat. No. 8,141,270, issued 27 Mar. 2012 in the name of Michael E. Gerra, Jr., and assigned to Maguire Products, Inc.

This patent application further incorporates by reference the disclosure of United States patent publication US 2015/0316320, published 5 Nov. 2015, entitled “Method and Apparatus for Vacuum Drying Granular Resin Material,” submitted by Stephen B. Maguire and Michael E. Gerra, Jr.

### BACKGROUND OF THE INVENTION

### Field of the Invention

This invention relates to apparatus and means for control of hot air flow used in drying granular resin material preparatory to that material being molded or extruded into finished or semi-finished plastic products.

### Description of the Prior Art

Use of hot air drying to prepare granular resin material for molding or extrusion is known. Heretofore, it has been customary and regular practice to provide a single drying apparatus in the form of a heater and blower for a storage hopper in which granular plastic resin material is stored and heated to a prescribed temperature, thereby to dry the granular plastic resin material to a required degree of dryness prior to molding or extrusion. The granular material must be dry in order to prevent formation of bubbles of moisture in the finished molded or extruded plastic product.

With the development of various different polymers used in extrusion and molding to form finished plastic products, there are associated with those polymers different temperature requirements and moisture requirements for successful molding or extrusion.

Cost of the various different polymer products used for molding or extrusion varies greatly according to the polymer used. Hence it may be expensive to mold small parts of a given polymer, and yet inexpensive to mold large numbers of large parts from a second polymer. Accordingly, molding facilities feel a need for hoppers of various sizes operating a various drying temperatures to accommodate various different polymer materials for molding, in order to compete on an economic basis with competitors. This invention addresses that need.

### SUMMARY OF THE INVENTION

When a dryer for granular material is a “central” dryer, meaning using one heater supplying dry, heated air to several hoppers drying granular material, in which the granular material is dried by the air furnished by the single heater, balancing the heated drying air flow among the several drying granular material hoppers is an issue. Typically, each hopper may have a different drying air temperature requirement and a different request for heated drying air, in cubic feet per minute, in order to dry correctly. If one hopper happens to be empty, all of the heated drying air takes the path of least resistance through the empty hopper and the supply of heated drying air in cubic feet per minute to the other hoppers, all of which are connected to the central heater and blower, stops.

This invention addresses this problem by providing valves to balance the drying heated air flow to the drying hoppers in cubic feet per minute, and, when needed, shutting one or more of the hoppers off, blocking flow of heated drying air to the hopper altogether.

Desirably, each hopper is heated separately, since the required temperature is different for each hopper depending on the type of granular material being heated and dried. The required cubic feet per minute of drying heated air for each hopper may be computed by measuring energy usage for each hopper and/or air temperature increases within the hopper. With that information, the invention automatically provides for opening or closing air flow dampers, desirably in the form of butterfly valves, to allow exactly the correct amount of heated drying air flow at the correct temperature for the particular hopper as specified by a microprocessor governing operation of the system.

In one of its aspects, this invention provides apparatus for simultaneous drying a plurality of different polymer materials preparatory to molding or extrusion of those materials into finished or semi-finished plastic products formed of different plastics. In this aspect of the invention, the apparatus includes a heater for heating air to be used for drying the materials, a blower for drawing air through the heater, a collection of hoppers with at least one hopper for each of the different polymer materials to be dried, with each hopper having a heating air inlet, a resin material inlet, and a dried polymeric resin material outlet, damper that controls the rate of heated air flow through the associated hopper, a collection of conduits connecting the blower with the hoppers, a plurality of air speed sensors, one on each conduit at the heating air inlet of a hopper for measuring speed of heated air entering the heated air inlet of the associated hopper, and a microprocessor connected to the heater, the blower, the air speed sensors and the dampers, for regulating the heater and/or the blower and/or the damper(s) in response to data received from the air speed sensors to regulate air speed and heat input to the blowers to heat and thereby dry the material therein.

In yet another one of its aspects this invention provides apparatus for simultaneously drying a plurality of different polymer materials preparatory to molding or extrusion of those materials into finished or semi-finished plastic products formed of different plastics. In this aspect of the invention, the apparatus includes a heater for heating air to be used for drying the polymer materials, a blower for drawing air through the heater, a collection of hoppers for the different polymer materials to be dried with each hopper having a heating air inlet, a polymer material inlet, a polymer material outlet, and with at least some of the hoppers having damper valves for limiting volume of heating air exiting the hopper. The apparatus in this embodiment of the invention preferably further includes a collection of conduits connecting the blower with the hoppers, a plurality of air speed sensors for measuring speed of heating air entering the heating air inlet of an associated hopper and a microprocessor connected to the heater, the blower, the air speed sensors, and the damper valves, for regulating the heater and/or the blower and/or one or more of the air speed sensors and/or one or more of the damper valves in response to data received from the air speed sensors to regulate heat input to the hoppers to dry the polymer material therein.

In still another aspect of the invention, the invention provides apparatus for drying a plurality of polymer materials preparatory to molding or extrusion of those materials into finished or semi-finished plastic products. In this aspect of the invention the invention includes a heater for heating air to be used for drying the polymer materials, a blower for drawing air through the heater, a collection of hoppers for the polymer materials to be dried, with each hopper having a heating air inlet, a polymer material inlet, a polymer material outlet, and at least some of the hoppers having damper valves for limiting volume of heating air leaving the hopper. In this one of its aspects, the invention further includes a collection of conduits connecting the blower with the hoppers. The invention yet further includes in this one of its aspects, a plurality of heat input sensors positioned in at least some of the conduits at the heating air inlet of a respective hopper, for measuring heat entering the heating air inlet of the associated hopper. Each heat input sensor in this aspect of the invention comprises a sensor for measuring temperature of heating air entering the associated hopper, a sensor for measuring relative humidity of heating air entering the hopper, and a memory for retaining data respecting parameters for the heating air inlet. In this aspect of the invention, the invention further provides a microprocessor connected to the heater, the blower, the damper valves, and the heat input sensors for regulating the heater and/or the blower and/or one of more of the damper valves in response to data received from the heat input sensor to regulate heat input to the to the hoppers to dry the polymer material therein.

In still another one of its aspects, this invention provides apparatus for simultaneously drying a plurality of different polymer materials preparatory to molding or extrusion of those materials into finished or semi-finished plastic products where the apparatus includes a heater for heating air to be used for drying the polymer materials, a blower for drawing air through the heater, a collection of hoppers for the different polymer materials to be dried, each hopper having a heating air inlet, a polymer material inlet, a polymer material outlet, and at least some of the hoppers having damper valves for limiting volume of heating air leaving the hopper. The apparatus further includes a collection of conduits connecting the blower with the hoppers and a plurality of heat input sensors with the heat input sensors being positioned in at least some of the conduits at the heating air inlet of a respective hopper. The heat input sensors measure heat entering the heating air inlet of the associated hopper. Each heat input sensor includes a sensor for measuring temperature of heating air entering the associated hopper and a sensor for measuring relative humidity of heating air entering the hopper. In this one of its aspects, the invention further includes a microprocessor having a memory for retaining date respecting the heating air inlet with the microprocessor being connected to the heater, the blower, the damper valves, and the heat input sensors for regulating the heater and/or the blower and/or one or more of the damper valves in response to data received from the heat input sensors to regulate heat input to the hoppers to dry the polymer material therein.

In yet another aspect of the invention, the invention provides a method for simultaneously drying a plurality of different polymer materials preparatory to molding or extrusion of those materials into finished or semi-finished plastic parts. The method commences by using a heater to generate heating air for drying the polymer materials. The method proceeds using a blower to draw the heating air through conduits to a collection of hoppers with at least one hopper for each of the different polymer materials to be dried, with each hopper having a heating air inlet, a polymer material inlet, a heated air outlet, and a damper valve thereon together with a polymer material outlet. The method proceeds by positioning a plurality of air speed sensors at the heating air inlets of the hoppers for measuring speed of heating air entering the heating air inlet of the associated hopper. The method further proceeds and concludes by regulating the heater and/or the blower and/or one or more of the air speed sensors, and/or one or more of the damper valves, using a microprocessor in response to data received from the air speed sensors to control heat input to the hoppers to dry the polymer material therein.

The following detailed description is merely exemplary in nature and is not intended to limit the described embodiments of the invention or uses of the described embodiments. As used herein, the words “exemplary” and “illustrative” mean “serving as an example, instance, or for illustration.” Any implementation or embodiment or abstract disclosed herein as being “exemplary” or “illustrative” is not necessarily to be construed as preferred or advantageous over other implementations, aspects, or embodiments. All of the implementations or embodiments described in the detailed description are exemplary implementations and embodiments provided to enable persons of skill in the art to make and to use the implementations and embodiments as disclosed below, to otherwise practice the invention, and are not intended to limit the scope of the invention, which is defined by the claims.

Furthermore, by this disclosure, there is no intention on the part of the Applicant to be bound by any express or implied theory presented in the preceding materials, including but not limited to the summary of the invention or the description of the prior art, or in the following detailed description of the invention. It is to be understood that the specific implementations, devices, processes, aspects, and the like illustrated in the attached drawings and described in the following portion of the application, usually referred to as the “specification,” are simply exemplary embodiments of the inventive concepts defined in the claims. Accordingly, specific dimensions and other physical characteristics relating to the embodiments disclosed herein are not to be considered as limiting as respecting the invention unless the claims or the specification expressly state otherwise.

### DESCRIPTION OF THE DRAWING

FIG. 1 is a schematic representation of a hot air-based granular resin material drying system in accordance with the invention.

FIG. 2 is a schematic representation of another hot-air based granular resin material drying system in accordance with the invention.

### DESCRIPTION OF THE INVENTION

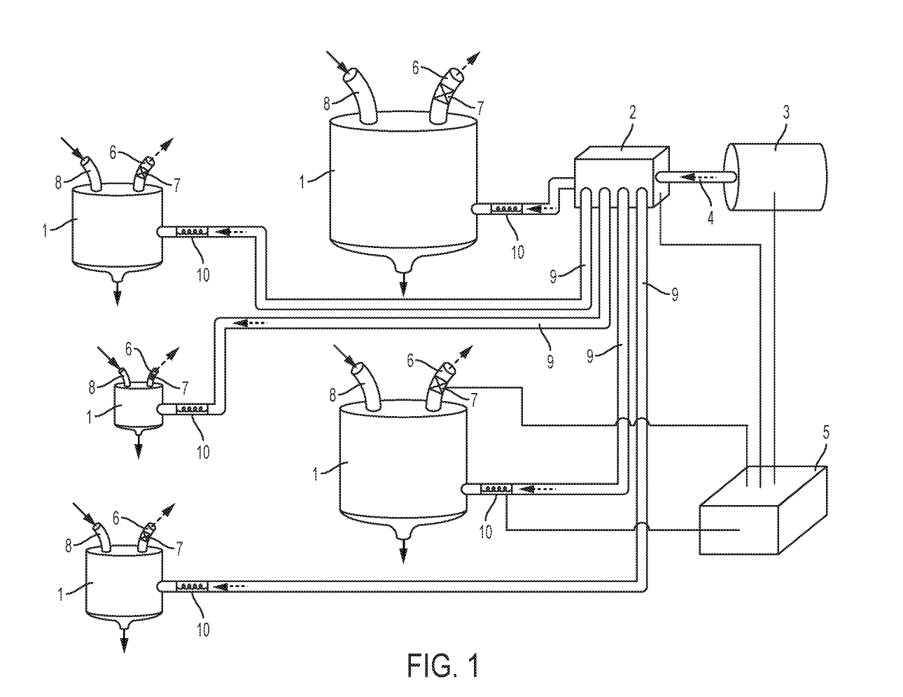

Referring to FIG. 1, item 1 in each instance denotes a heated drying hopper for granular materials. In the drawing, heated drying hoppers 1 have been drawn in different sizes to denote that the system is adapted to provide drying heated air to drying hoppers of differing size simultaneously with each drying hopper receiving the appropriate, required amount of drying heated air on a continuous basis. Each drying hopper includes an exit air flow damper valve 7, desirably in the form of a butterfly valve, to allow exactly the correct amount of drying heated air flow through the particular hopper 1 as specified by a microprocessor 5 governing operation of the system.

Still referring to FIG. 1, item 1 in each instance denotes a heated drying hopper for granular materials, and in the drawing, heated drying hoppers 1 have been drawn in different sizes to denote that the system is adapted to provide drying heated air to drying hoppers of differing size simultaneously, with each drying hopper 1 receiving the appropriate and required amount of drying heated air on a continuous basis.

Further referring to FIG. 1, a blower 3 delivers air via a conduit 4 to a heater/manifold 2. Each one of hoppers 1 is connected by a conduit 9 to heater/manifold 2 to receive warm air from heater/manifold 2 via one of conduits 9.

Each heated drying hopper 1 has a warm air outlet conduit 6 via which heated air can escape from the hopper. Each outlet conduit 6 includes a damper valve 7, which is preferably connected to a microprocessor 5. In FIG. 1, some wiring to and from microprocessor 5 has been illustrated as exemplary. The drawing does not show wiring from each damper valve 7 to microprocessor 5 because the connection is most desirably implemented in a wireless manner. Microprocessor 5 is preferably also connected to blower 3 and to heater/manifold 4, as illustrated. These connections, which show schematically as wires, are most desirably wireless such as via Internet or Bluetooth.

As with the drying hoppers 1, the hopper conduit outlets 6 are preferably of differing sizes; just as drying hoppers 1 are of differing sizes.

In the FIG. 1 embodiment, each conduit 9 houses an air speed detector 10, which is desirably adjacent to the associated drying hopper 1.

Each heated drying hopper 1 has a granular material inlet conduit 8 connected to it for feed of granular material to the associated hopper. As with the hoppers 1 and the heated air outlet conduits 6, the granular material inlet conduits 8 are of differing sizes.

Each heated drying hopper 1 has an unnumbered granular material outlet at the hopper bottom.

Arrows in FIG. 1 indicate air and granular material flows. Solid lines leading to arrowheads indicate granular material flows while dotted lines leading to arrowheads indicate air flows.

In the embodiment of the invention illustrated in FIG. 1, it is desirable and expected that heater/manifold 2 will produce sufficient heat and be supplied with sufficient air by blower 3 that the hot air reaching various ones of hoppers 1 will be substantially all the same temperature. This may be accomplished by providing insulation on conduits 9 to limit heat loss from conduits 9 within a given molding or extrusion facility. With the air temperature of the heating air supplied by a conduit 9 to a drying hopper 1 being known and relatively constant, air speed indicator 10 supplying microprocessor 5 the speed of air entering a given hopper 1 allows microprocessor 5 to compute whether granular polymeric material in a given hopper 1 is at a proper temperature for drying or is at an excessively high temperature and/or moisture content for drying.

If microprocessor 5 detects that the temperature within a given drying hopper 1 is excessive for molding or extrusion of the particular polymeric material being dried in that hopper, microprocessor 5 opens damper/valve 7 associated with the particular drying hopper 1 to allow more heated air to escape from drying hopper 1, thereby reducing the temperature of polymeric material being dried in drying hopper 1. Microprocessor 5 has programmed into it the engineering data such as conduit diameter and the like, and material data such as maximum heating temperature for drying of a particular polymer and maximum moisture level for drying a particular polymer, so that microprocessor 5, upon receiving the air speed of the heated air entering a particular drying hopper 1, can rapidly compute the temperature of the polymer material within drying hopper 1 and, if necessary, open the damper valve 7 of that particular drying hopper 1 in order to cool the polymeric material therein to the desired temperature for drying.

Under normal conditions, heater manifold 2 is set to provide heated drying air at a maximum temperature that is no higher than the maximum temperature for drying of any of the polymeric materials being dried, as set by the manufacturer of the polymeric material. Accordingly, unless there is a malfunction in the system, normally damper valves 7 are open and there is no excess heat buildup within a drying hopper 1 since the temperature of air being input to drying hopper 1 is at or below the maximum recommended temperature for drying the particular polymer that is in the relevant drying hopper 1.

If by chance the moisture content of the granular polymeric material in the hopper of interest is too high for molding, microprocessor 5 will close damper valve 7 somewhat to allow the temperature of the granular polymeric material for molding to rise to the maximum permitted temperature for molding that particular granular polymer material. If by chance the temperature of the granular polymeric material in a hopper 1 of interest is at the maximum temperature for molding and the moisture content is still too high for molding, microprocessor 5 will open damper valve 7 and will modulate damper valve 7 as needed to maintain the granular polymeric material at the maximum allowable temperature for molding while permitting the material to continue to dry, until the moisture content of the material drops to the level at which successful molding or extrusion can occur.

In the course of practice of the method of the invention, as is immediately apparent to one of skill in the art from an inspection of FIG. 1, the method acts to simultaneously dry a plurality of different polymer materials preparatory to molding or extrusion of those materials into finished or semi-finished plastic products. The method commences using a heater 2, generating heating air for drying the polymer materials. The method proceeds using a blower 3, blowing the heating air through conduits to a collection of hoppers 1 with at least one hopper 1 being furnished for each of the different polymer materials to be dried, with each hopper 1 having a heating air inlet, a polymer material inlet 8, a heated air outlet 6 with a damper valve 7 thereon, and a polymer material outlet.

The FIG. 1 method proceeds with positioning a plurality of air speed sensors 10, one each at the heating air inlets 6 of the hoppers 1. The sensors 10 measure speed of the heating air entering the heating air inlet of the associated hopper 1. The method further proceeds by regulating the heater 2, and/or the blower 3, and/or one or more of the air speed sensors 10, and/or one or more of the damper valves 7, using microprocessor 5 in response to data received from the air speed sensors 10, to control heat input to hoppers 1 to dry the polymer material therein. Note that microprocessor 5 may regulate heat input to each of hoppers 1 individually by opening/closing damper valve 7 associated with the hopper.

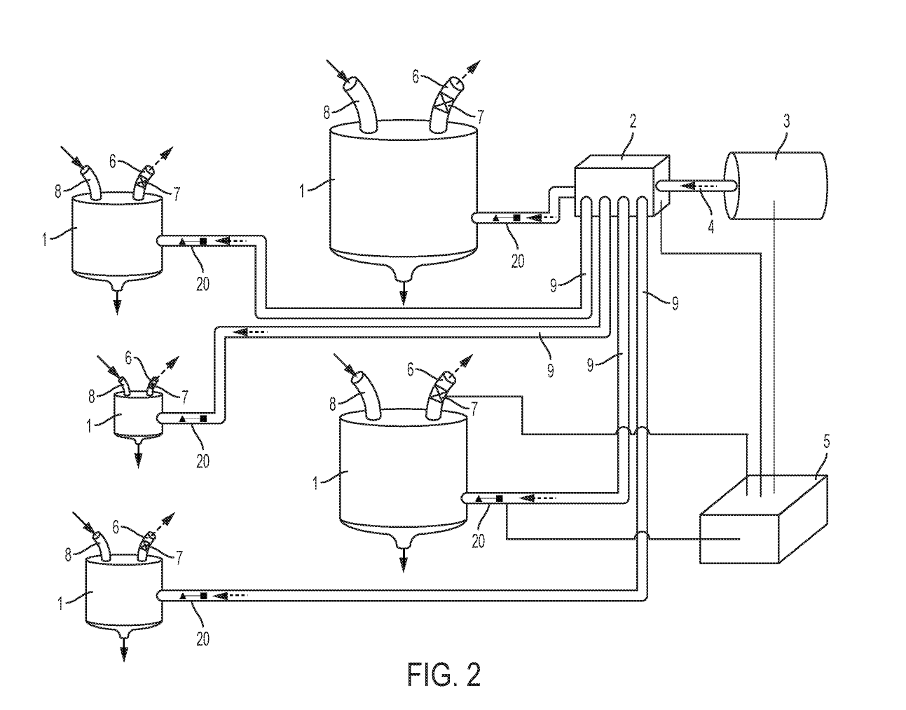

FIG. 2 illustrates a second embodiment of the invention that is quite similar in appearance to that of the embodiment of FIG. 1 but which differs in operation substantially from the embodiment illustrated in FIG. 1.

In FIG. 2 much like FIG. 1, there are a plurality of drying hoppers 1. A blower 3 supplies air via conduit 4 to a heater/manifold 2. The heater/manifold 2 heats the air as required and distributes the air into a collection of conduits 9 for transport of the heated air to various ones of drying hoppers 1. Each drying hopper, similarly to the drying hoppers illustrated in FIG. 1, has a granular polymeric material inlet conduit 8, a heated drying air outlet conduit 6, an exit air flow damper/valve 7 positioned within the associated heated drying air outlet conduit 6, and an unnumbered outlet for dried granular polymer material at the bottom of each of the hoppers 1. The outlets for the dried granular polymer material have not been numbered in FIG. 2 but are denoted by downwardly facing arrows at the lower surface of each hopper 1.

In FIG. 2, like FIG. 1, dotted line arrows denote flows of air whereas solid line arrows denote flows of granular polymeric material.

The place where the FIG. 2 embodiment differs most significantly from the FIG. 1 embodiment is the inclusion of heat input sensors 20 which are positioned in at least some of the conduits 9 at the heating air inlet of respective hoppers 1. These heat input sensors 20 measure heat entering the heating air inlet of the associated hopper 1. Each heat input sensor 20 includes a senor for measuring temperature of heating air entering the associated hopper and a sensor for measuring relative humidity of heating air entering the hopper. When this disclosure states that the heat input sensors measure heat entering the heating air inlet of the associated hopper, this denotes the process of one sensor measuring temperature of the heating air and another sensor at the same locale measuring relative humidity of the heating air so that microprocessor 5, when furnished with the data as to the temperature of the heating air and the relative humidity of the heating air at the inlet to the particular hopper 1, computes the amount of heat carried by the heating air through conduit 9 into hopper 1.

Microprocessor 5 includes a memory for retaining data respecting the heating air inlet geometry since the size and length of the conduit 9 and the size of the inlet into a drying hopper 1 dictate, to a large extent, the volume of heating air that may be supplied to conduit 1, assuming blower 3 operates at a constant speed and that resistance to air flow through heater/manifold 2 is essentially constant and fixed. These assumptions are quite valid for air moving at the relative low speeds involved in granular resin processing and molding and extrusion facilities; at these speeds air behaves as an incompressible fluid.

Microprocessor 5 computes the amount of heat being supplied to a drying hopper 1 and adjusts the associated damper valve 7 and/or the heater/manifold 2, and/or the blower 3 as required, so that heat input supplied to a drying hopper 1 does not cause temperature to exceed the maximum allowable temperature for the particular polymer material in drying hopper 1 that is being dried.

Among the data stored in microprocessor 5, for each of the polymer materials being dried, are data including specific heat, maximum permissible temperature for drying the polymer of interest, and the like. Also stored in microprocessor 5 is data respecting the parameters of each of the conduits 9, such as inner diameter, length from heater/manifold 2 to a relevant hopper 1, and the number and degree of blends in conduit 9 between heater/manifold 2 and a relevant hopper 1. Microprocessor 5 controls not only blower 3 and heater/manifold 2 as to the speed of blower 3 and the temperature that heater/manifold 2 imparts to air before as the air enters conduits 9; microprocessor 5 also communicates within and controls exit flow damper/valves 7 so as to regulate the amount of heat retained within a drying hopper 1. Microprocessor 5 also communicates with drying hoppers 1 to actuate valves, not illustrated, at the bottom of each drying hopper 1 to evacuate, by action of gravity, each drying hopper 1 of the granular polymer material therein once that material has reached the required level of dryness to be molded or extruded without moisture problems during the process.

Although schematic implementations of present invention and at least some of its advantages are described in detail hereinabove, it should be understood that various changes, substitutions and alterations may be made to the apparatus and methods disclosed herein without departing from the spirit and scope of the invention as defined by the appended claims. Moreover, the scope of this patent application is not intended to be limited to the particular implementations of apparatus and methods described in the specification, nor to any methods that may be described or inferentially understood by those skilled in the art to be present as described in this specification.

As one of skill in the art will readily appreciate from the disclosure of the invention as set forth hereinabove, apparatus, methods, and steps presently existing or later developed, which perform substantially the same function or achieve substantially the same result as the corresponding embodiments described and disclosed hereinabove, may be utilized according to the description of the invention and the claims appended hereto. Accordingly, the appended claims are intended to include within their scope such apparatus, methods, and processes that provide the same result or which are, as a matter of law, embraced by the doctrine of the equivalents respecting the claims of this application.

As respecting the claims appended hereto, the term “comprising” means “including but not limited to”, whereas the term “consisting of” means “having only and no more”, and the term “consisting essentially of” means “having only and no more except for minor additions which would be known to one of skill in the art as possibly needed for operation of the invention.”

I claim the Following:

1. Apparatus for simultaneously drying a plurality of different polymer materials preparatory to molding or extrusion of those materials into finished or semi-finished plastic products, comprising:
a) a heater for heating air to be used for drying the polymer materials;
b) a blower for drawing air through the heater;
c) a collection of hoppers, at least one hopper for each of the different polymer materials to be dried, each hopper having a heating air inlet, a polymer material inlet, and a polymer material outlet;
d) a collection of conduits connecting the blower with the hoppers;
e) a plurality of air speed sensors, at the heating air inlets of the hoppers for measuring speed of heating air entering the heating air inlet of the associated hopper;
f) a microprocessor connected to the heater, the blower, and to the air speed sensors, for regulating the heater and/or the blower and/or one or more of the air speed sensors in response to data received from the air speed sensors to regulate speed of heating air input to the hoppers to dry the polymer material therein.

2. Apparatus of claim 1 wherein the hoppers are of at least two different capacities.

3. Apparatus of claim 1 wherein each of the hoppers are of individual capacity differing from all of the other hoppers.

4. Apparatus of claim 3 wherein each of the different hoppers contains a different polymer material.

5. Apparatus of claim 1 further comprising a temperature sensor at the heating air inlet of at least some of the hoppers.

6. Apparatus of claim 1 further comprising a temperature sensor at the heating air inlet of each of the hoppers for measuring the temperature of heating air entering the associated hopper.

7. Apparatus of claim 1 further comprising an air speed sensor at the heating air inlet of each of the hoppers for measuring the speed of heating air entering the heating air inlet of the associated hopper.

8. Apparatus for simultaneously drying different polymer materials preparatory to molding or extrusion of those materials into finished or semi-finished plastic products, comprising:
a) a heater for heating air to be used for drying the polymer materials;
b) a blower for drawing air through the heater;
c) a collection of hoppers, for the different polymer materials to be dried, each hopper having a heating air inlet, a polymer material inlet, a polymer material outlet, and at least some of the hoppers having damper valves for limiting volume of heating air exiting the hopper;
d) a collection of conduits connecting the blower with the hoppers;
e) a plurality of air speed sensors for measuring speed of heating air entering the heating air inlet of an associated hopper;
f) a microprocessor connected to the heater, the blower, the air speed sensors, and the damper valves, for regulating the heater and/or the blower and/or one or more of the air speed sensors and/or one or more of the damper valves, in response to data received from the air speed sensors to regulate heat input to the hoppers to dry the polymer material therein.

9. Apparatus of claim 8 wherein the hoppers are of at least two different capacities.

10. Apparatus of claim 8 wherein each of the hoppers are of individual capacity differing from all of the other hoppers.

11. Apparatus of claim 10 wherein each of the different hoppers contains a different polymer material.

12. Apparatus for simultaneously drying a plurality of different polymer materials preparatory to molding or extrusion of those materials into finished or semi-finished plastic products, comprising:
a) a heater for heating air to be used for drying the polymer materials;
b) a blower for drawing air through the heater;
c) a collection of hoppers for the different polymer materials to be dried, each hopper having a heating air inlet, a polymer material inlet, a polymer material outlet, and at least some of the hoppers having damper valves for limiting volume of heating air leaving the hopper;
d) a collection of conduits connecting the blower with the hoppers;
e) a plurality of heat input sensors, positioned in at least some of the conduits at the heating air inlet of a respective hopper, for measuring heat entering the heating air inlet of the associated hopper, each heat input sensor comprising:
i) a sensor for measuring temperature of heating air entering the associated hopper;
ii) a sensor for measuring relative humidity of heating air entering the hopper; and
f) a microprocessor including a memory for retaining data respecting the heating air inlet, being connected to the heater, the blower, the damper valves, and the heat input sensors, for regulating the heater and/or the blower and/or one or more of the damper valves in response to data received from the heat input sensors to regulate heat input to the hoppers to dry the polymer material therein.

13. Apparatus of claim 12 wherein the hoppers are of at least two different capacities.

14. Apparatus of claim 13 wherein each of the hoppers are of individual capacity differing from all of the other hoppers.

15. Apparatus of claim 14 wherein each of the different hoppers contains a different polymer material.

16. A method for simultaneously drying a plurality of different polymer materials preparatory to molding or extrusion of those materials into finished or semi-finished plastic products, comprising:
a) by using a heater, generating heating air for drying the polymer materials;
b) by using a blower, drawing the heating air through conduits to a collection of hoppers, at least one hopper for each of the different polymer materials to be dried, each hopper having a heating air inlet, a polymer material inlet, a heated air outlet with a damper valve thereon, and a polymer material outlet;
c) positioning a plurality of air speed sensors, at the heating air inlets of the hoppers for measuring speed of heating air entering the heating air inlet of the associated hopper; and
d) regulating the heater, and/or the blower, and/or one or more of the air speed sensors, and/or one or more of the damper valves, using a microprocessor in response to data received from the air speed sensors to control heat input to the hoppers to dry the polymer material therein.

17. The method of claim 16 further comprising controlling the heater wirelessly.

18. The method of claim 16 further comprising controlling the blower wirelessly.

19. Apparatus of claim 8 wherein the connection of the microprocessor to the heater, the blower, the air speed sensors, and the damper valves is wireless.

20. Apparatus of claim 8 wherein the connection to at least one of the heater, the blower, at least one of the air speed sensors, and at least one of the damper valves, is wireless.
